(19) United States
(12) Patent Application Publication
(10) Pub. No.: US 2016/0179909 A1
(43) Pub. Date: Jun. 23, 2016

(54) METHOD AND SYSTEM FOR TRACKING TOOLS

(71) Applicants: Shawn Rodney Wells, Fairbury, IL (US); Tonya Kay Wells, Fairbury, IL (US)

(72) Inventors: Shawn Rodney Wells, Fairbury, IL (US); Tonya Kay Wells, Fairbury, IL (US)

(21) Appl. No.: 14/581,589

(22) Filed: Dec. 23, 2014

(51) Int. Cl. G06F 17/30; G06Q 10/08

(52) U.S. Cl. CPC G06F 17/30554; G06Q 10/087; G06F 17/30424; G06F 17/30389

(57) ABSTRACT

A system and method allows workers on a jobsite to track their use and/or location of tools. The system can include a plurality of barcodes that can be placed directly on each of the tools to be tracked. The system further includes a mobile application that can operate on a mobile electronic device, such as a smart phone, that can scan the barcode, thus assigning the tool to a specific worker on the jobsite. A database can be incorporated on a central computer, such as a computer server, to relate each barcode to each tool and track which users have signed out and/or signed in each tool. In some embodiments, such as on large jobsites, the system may track, via GPS, for example, the location of the electronic device that has signed out the tool.

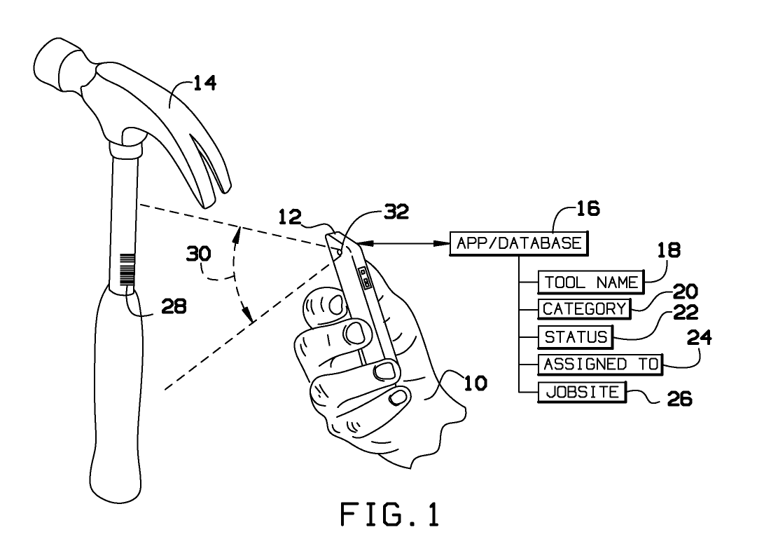

### BACKGROUND OF THE INVENTION

The present invention relates to methods and systems for tracking tools and, more particularly, to a mobile application that can scan barcodes on tools and track the tools, for example, on construction jobsites.

Tracking and managing tools on construction jobsites is difficult and confusing. Often, tools are kept in one or more centralized tool storage locations. When a user needs a specific tool, there is no way to know if another worker has taken the tool or where the tool may be located. This can be especially problematic with specialized tools on large or expansive jobsites. Searching for tools or determining who may be using a certain tool at a given time can be time consuming and result in loss or productivity.

Conventional tracking systems use an expensive machine to do the scanning of the barcodes. These machines need to be set up at each tool storage location. Moreover, these conventional machines cannot track the location of the tool unless the user goes to a machine and updates the tracking data.

As can be seen, there is a need for an easy and convenient method and system for tracking tools on a jobsite.

### SUMMARY OF THE INVENTION

In one aspect of the present invention, a method for tracking tools, comprises: selecting one of a single tool scan option and a multiple tool scan option via software executing on a mobile device; scanning a barcode label on at least one tool with the mobile device; sending information scanned from the barcode label to a database disposed on a server computer; entering, within the database, an identification of the tool associated with the information scanned from the barcode label via software executing on a computer; scanning a barcode label of at least one identified tool with a mobile device; identifying a user of the mobile device used to scan the barcode label of the at least one identified tool; and assigning, within the database, the tool with the user of the mobile device.

In another aspect of the present invention, a method for tracking tools, comprises: entering a plurality of identified tools to a database via software executing on a computer, wherein each of the identified tools is associated with a barcode; entering a plurality of users to a database via software executing on a computer, wherein each user is associated with a mobile device; scanning a barcode label of at least one of the identified tools with a mobile device; identifying a user of the mobile device used to scan the barcode label of the at least one identified tool; and assigning, within the database, the tool with the user of the mobile device.

These and other features, aspects and advantages of the present invention will become better understood with reference to the following drawings, description and claims.

### BRIEF DESCRIPTION OF THE DRAWINGS

The FIGURE is a schematic representation of the use of a tool tracking mobile application according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method for allowing workers on a jobsite to track their use and/or location of tools. The system can include a plurality of barcodes that can be placed directly on each of the tools to be tracked. The system further includes a mobile application that can operate on a mobile electronic device, such as a smart phone, that can scan the barcode, thus assigning the tool to a specific worker on the jobsite. A database can be incorporated on a central computer, such as a computer server, to relate each barcode to each tool and track which users have signed out and/or signed in each tool. In some embodiments, such as on large jobsites, the system may track, via GPS, for example, the location of the electronic device that has signed out the tool.

In today's society, many people own or use smart phones or other such mobile devices. To use the system and methods of the present invention, a user can simply download the appropriate application for their device, link to their jobsite database, or some other centralized database, and scan the tools as they are used and/or returned. Should a tool become missing, one can easily review that specific tool's use history and follow-up with the prior user of the tool.

Referring now to the FIGURE, a user 10 can use a mobile device 12, such as a smart phone, tablet computer, or the like, to scan a barcode label 28 disposed on a tool 14. The barcode label 28 may be a 2-dimensional barcode, as shown, or other type of barcode as may be known in the art. The barcode label 28 can be disposed on the tool 14 in various manners, such as via an adhesive. In some embodiments, the barcode label 28 may be integrated into the tool, such as via an etching process or the like.

The mobile device 12 can include a scanning mechanism, such as a camera 32 that can scan the barcode label 28. The camera 32 can have a field of view 30 such that, when adjacent to the barcode label 28, the camera 32 can scan the label 28 and read the data thereupon.

A database 16 can be set up to store data related to the tools 14, the barcode labels 28 and the users 10. The database 16 can reside on a computing device, such as a computer server. The mobile device 12 can communicate with the database 16 via various mechanisms, including an internet connection (such as wireless, WiFi, 3G, 4G or the like), SMS message, or the like. When the barcode label 28 on a tool 14 is scanned, the mobile device 12 can send information to the database 16, such as information that identifies the tool (such as barcode label information), time scanned, user that scanned the tool, the jobsite the tool is assigned, and the like.

The database 16 can include various information, such as tool name 18, tool category 20, tool status 22, the user to which the tool is assigned 24 and the jobsite 26. The database 16 may be specific to one or more jobsites. Other information may also be included in the database 16, such as the number of similar tools available, amount of time tools are checked out, and the like. These statistics may be useful for jobsite managers to allocate tools to minimize workers needing tools that are in use as well as to minimize having extra tools at a jobsite that are not used. For example, a jobsite manager may review data to see that all four hammers are checked out 90% of the time. In this case the jobsite manager may desire to place a fifth hammer at the jobsite to assure availability. However, if only one of the four hammers at a jobsite has been used at a time in the past, the jobsite manager may be able to remove one or two hammers for use on a different site.

Therefore, not only will the system and methods of the present invention track tools, their users, and their location, but the present invention may also be useful for jobsite management. For example, the system of the present invention may send a message to a user, or a jobsite manager, when the user leaves a jobsite but still have one or more tools assigned to them. This can help ensure the user is aware of what tools are still assigned to them on a daily basis. The trigger for sending such a message may be based on time of day, user location, or the like.

In some embodiments, a barcode label 28 may be applied to the tool storage location. In this embodiment, a user may scan the barcode label of the tool first, then the barcode label off the tool storage location, thereby associating the tool with the location from which it was obtained. Similarly, when returning a tool to a tool storage location, the user may scan the barcode labels on both the tool and the tool storage location to designate the location to which the tool was returned. This may be helpful on jobsites where more than one tool storage location is present.

In some embodiments, the user's mobile device 12 may be equipped with a location tracking device, such as a GPS device. In this embodiment, not only can the system determine who has the tool, but their location. This can be especially useful for a specialized tool on a large jobsite. There only may be one of these tools present, but a user may be able to search within the mobile device application to determine who has the tool and where they are located.

The system of the present invention may include both hardware and software components. The hardware components may include the barcode labels 28, the mobile devices 12 and the database 16. The software component can include a mobile device application that can permit the mobile device 12 to scan the barcode labels and also permit the mobile device 12 to interact with the database 16. The software component can also include a desktop or server based software application that can access the database to track tools, users, enter data, perform jobsite management, and the like.

In certain embodiments, the software component of the present invention may display an option of selecting one of a single tool scan option and a multiple tool scan option on the mobile device. When a user selects a single tool scan option, the user may perform the steps outlined above. When a user selects multiple tool scan option, the user may scan a plurality of barcode labels at once with the mobile device. The information scanned from the barcode labels is send to the database. The information scanned from the barcode labels each include a designator. A plurality of designators associated with the information scanned from each of the plurality of barcode labels is displayed by a computer. The user may then select a designator from the plurality of designators and enter an identification of the tool associated with the designator. Therefore, a user may quickly scan multiple tools, select the designators of the tools, and enter identifying information about the tools.

In alternate embodiments, a list of tools may be prepared with identifying information in a software program, such as Excel®. Each of the tools on the list may be designated with a different barcode label. The list of tools may be uploaded to the database of the present invention. When a mobile device scans one of the barcode labels, the tool already including the identifying information may be assigned to the mobile device.

In certain embodiments, a plurality of users may be entered into the database. Each of the plurality of users may be associated with a different mobile device. Therefore, when a mobile device scans the barcode labels, the tool is assigned to a mobile device and the user that is associated with the mobile device.

In certain embodiments, a search bar is provided via the software in order to search for at least one of an identified tool and a user within the database. Therefore, a user may search the database to find the tool as well as the user assigned to the tool, or the storage unit in which the tool is stored. Further, if a construction site includes multiple sites, the site in which the tool is in may be displayed. A call option may be displayed with each associated user and mobile device. Therefore, a user searching for a tool may instantly call the user in which the tool is assigned.

The software component of the present invention may display a plurality of navigation icons on a computer, such as the mobile device. A Tool Service History icon may be for tools and equipment that need to be serviced on a regular basis. This will keep an ongoing record of when the tool was serviced and when it will need service in the future along with a notification that the service will be due soon. A Help icon may be a direct email through the system asking for help with any problems that you may experience with the app or desktop version. The Help icon may be located on the desktop dashboard and in the software application. The present invention may further include a list icon. After clicking on the list icon a user will be able to select from a list of all of the following to download to your computer to a spreadsheet: Tools—a list of tools downloaded to a spreadsheet on the computer with a complete list of tools scanned into the system, where they are and how many of each that the company owns; Users—a list of crew members (users) downloaded to a spreadsheet on the computer including crew member and contact information; Jobsites—a list of jobsites downloaded to a spreadsheet on the computer including Jobsites with addresses and PO numbers, In-charge, and tool list for the jobsite; Tool Maintenance History—a tool maintenance history downloaded to an Excel spreadsheet onto your computer for tools that aren't working properly or have broken on the jobsite and need to be maintenance which keeps a record of who entered the tool into maintenance, which jobsite that the tool came from, what is wrong with the tool, date it was entered into maintenance, what was done to it; and Tool Service History—a tool Service history is downloaded to a spreadsheet onto your computer, the Tool Service history is for tools that need to be serviced on a regular basis and the present invention keeps a record of service dates.

While the present invention is described for use on jobsites, the tool tracking system and method may be used to track tools in other industries, such as rental tools. Moreover, the tracking system and method may be used to track other items and may be useful for inventory control, for example.

It should be understood, of course, that the foregoing relates to exemplary embodiments of the invention and that modifications may be made without departing from the spirit and scope of the invention as set forth in the following claims.

What is claimed is:

1. A method for tracking tools, comprising:
selecting one of a single tool scan option and a multiple tool scan option via software executing on a mobile device;
scanning a barcode label on at least one tool with the mobile device;
sending information scanned from the barcode label to a database disposed on a server computer;
entering, within the database, an identification of the tool associated with the information scanned from the barcode label via software executing on a computer;
scanning a barcode label of at least one identified tool with a mobile device;
identifying a user of the mobile device used to scan the barcode label of the at least one identified tool; and
assigning, within the database, the tool with the user of the mobile device.

2. The method of claim 1, wherein the multiple tool scan option comprises the steps of:
scanning a plurality of barcode labels on each of a plurality of tools with the mobile device;
sending information scanned from the plurality of barcode labels to the database disposed on the server computer;
displaying a plurality of designators associated with the information scanned from each of the plurality of barcode labels via software executing on a computer;
selecting a designator from the plurality of designators via software executing on a computer; and
entering, within the database, an identification of the tool associated with the designator via software executing on a computer.

3. The method of claim 1, further comprising the step of scanning a barcode label on the at least one identified tool a second time to indicate return of the tool to a tool storage location.

4. The method of claim 1, further comprising scanning a second barcode label on a tool storage location to indicate where the tool was obtained by the user.

5. The method of claim 1, further comprising the step of tracking a location of the mobile device of the user via a global positioning satellite system integrated into the mobile device.

6. The method of claim 1, wherein the database includes data with respect to one or more jobsites.

7. The method of claim 1, further comprising the step of sending a message to the mobile device of the user to inform the user of tools remaining assigned to them.

8. The method of claim 1, wherein a plurality of users is entered into the database, wherein each of the plurality of users is associated with a different mobile device.

9. The method of claim 8, further comprising the step of providing a search bar via software executing on a computer, wherein the search bar allows a user to search for at least one of an identified tool and a user.

10. The method of claim 9, further comprising the steps of:
searching for an identified tool in the database via software executed on a mobile device;
displaying the identified tool and the assigned user on the mobile device; and
displaying a call option, wherein selecting the call option comprises communication from the mobile device to a mobile device of the assigned user.

11. A method for tracking tools, comprising:
entering a plurality of identified tools to a database via software executing on a computer, wherein each of the identified tools is associated with a barcode;
entering a plurality of users to a database via software executing on a computer, wherein each user is associated with a mobile device;
scanning a barcode label of at least one of the identified tools with a mobile device;
identifying a user of the mobile device used to scan the barcode label of the at least one identified tool; and
assigning, within the database, the tool with the user of the mobile device.

12. The method of claim 11, further comprising the step of scanning a barcode label on the at least one identified tool a second time to indicate return of the tool to a tool storage location.

13. The method of claim 11, further comprising scanning a second barcode label on a tool storage location to indicate where the tool was obtained by the user.

14. The method of claim 11, further comprising the step of tracking a location of the mobile device of the user via a global positioning satellite system integrated into the mobile device.

15. The method of claim 11, wherein the database includes data with respect to one or more jobsites.

16. The method of claim 11, further comprising the step of sending a message to the mobile device of the user to inform the user of tools remaining assigned to them.

17. The method of claim 11, further comprising the step of providing a search bar via software executing on a computer, wherein the search bar allows a user to search for at least one of an identified tool, a user, and a jobsite.

18. The method of claim 17, further comprising the steps of:
searching for an identified tool in the database via software executed on a mobile device;
displaying the identified tool and the assigned user on the mobile device; and
displaying a call option, wherein selecting the call option comprises communication from the mobile device to a mobile device of the assigned user.
